(19) United States
(12) Patent Application Publication
(10) Pub. No.: US 2008/0086743 A1
(43) Pub. Date: Apr. 10, 2008

(54) Enhanced personal video recorder

(75) Inventors: Monsong Cheng, Katonah, NY (US); Huey-Shiang (Sharon) Chen, Katonah, NY (US); Aubrey Flanagan, Franklin Park, NJ (US); Bodhi Muhkerjee, Hopewell JN, NY (US)

Correspondence Address: STEPHEN B. ACKERMAN, 28 DAVIS AVENUE, POUGHKEEPSIE, NY, 12603, US

(73) Assignee: InfoValue Computing, Inc.

(21) Appl. No.: 11/724,411

(22) Filed: Mar. 15, 2007

Related U.S. Application Data
(60) Provisional application No. 60/850,323, filed on Oct. 6, 2006.

(51) Int. Cl. H04N 5/445

(52) U.S. Cl. 725/38

(57) ABSTRACT

A personal video recorder coupled to a server provides a capability to record one or more missed portions of a TV program. The personal video recorder provides a way for a user to record the full content of a TV program even though the personal video recorder was not activated at the beginning of the TV program. The personal video recorder is coupled through a network to a server associated with a storage system, which records the entire TV program. The user, upon deciding to record the TV program after the TV program has started, requests the personal video recorder to obtain the missed beginning portion. The personal video recorder signals the server through the network with the TV program ID and the time at which recording started. The server responds with an address and data range, which the personal video recorder uses to download the missed portion of the TV program.

This application claims priority to Provisional Patent Application Ser. No. 60/850,323, filed on Oct. 6, 2006, which is herein incorporated by reference in its entirety.

### BACKGROUND OF THE INVENTION

1. Field of Invention

The present invention relates to video recording and in particular to spontaneous recording of a TV program or video, whereby the beginning of the TV program or video is recorded upon starting of a viewing of the TV program or video at some point after the beginning.

2. Description of related art.

Personal video recording provides a flexibility to allow recording a TV program for viewing at a future time and simultaneously recording a TV program during the viewing of the TV program for replay at some future time. In order to record the entire TV program requires an individual to plan ahead and set a video recorder to start based on a published schedule. If an individual is surfing through TV channels and comes upon a program of interest after the program has started, any recording of that program can only begin at the point where the individual started viewing, and the beginning of the TV program can only be recorded upon a rescheduling of the program by the broadcaster of the program.

In U.S. Pat. No. 7,114,172 a method, apparatus and system is directed to synchronizing the video output of personal video recorders in two or more locations, wherein a broadcast program is received and recorded on one of the personal video recorders. U.S. Pat. No. 7,107,606 is directed to a system and method for providing video on demand for pre-scheduled multicasts of videos and initiated transmissions of the front portion of the videos. U.S. Pat. No. 6,701,528 is directed to a method and apparatus for providing virtual video on demand, wherein a segment of the video program is stored in advance of the video on demand viewing at a latter time. U.S. Pat. No. 6,622,305 is directed to a method for display of near video on demand that are broadcast over a network to a receiver, which records at least one broadcast channel. U.S. Pat. No. 6,483,986 is directed to a method to permit a viewer alternate subject matter while receiving streaming video without loss of the streaming video.

U.S. Pat. No. 6,480,667 is directed a means for receiving a video stream and recording the video stream onto a storage unit while a portion of the video stream is retrieved for viewing. In U.S. Pat. No. 6,434,748 an apparatus is directed to providing VCR like “trick mode” functions comprising pause, fast-forward and rewind in a distributed video on demand program environment. U.S. Pat. No. 6,327,418 is directed to a continuous stream of digital data, i.e. video and audio data, with a virtual segment where non-linear playback such as rewind, pause, fast forward and frame advance can implemented even though a continuous data stream does not cease. U.S. Pat. No. 6,233,389 is directed to a multimedia time warping system where a user stores a selected television program while simultaneously watching or reviewing another program.

In U.S. Pat. No. 5,706,388 a recording system is directed to a viewing operation for previously recorded data without stopping a recording operation of data currently being received. U.S. Pat. No. 5,696,868 (Kim et al.) is directed to an apparatus and a method for recording and playing back a broadcast signal, wherein the broadcast signal is separated into video and audio and written separately into video and audio memories. In U.S. Pat. No. 5,682,597 a system and method is directed to video on demand to accommodate video surfing, wherein a server operates in near video on demand mode, whereby the server continuously sends multiple copies of each program on separate channels allowing a user to perform asynchronous operations. U.S. Pat. No. 5,534,912 is directed to a video on demand system utilizing asymmetric digital subscriber line interface to produce an extended video on demand distribution system. U.S. Pat. No. 5,438,423 is directed to a time warping for video viewing by providing a random access dynamic buffer for a video signal from a selected video channel where the video signal is continuously fed into the dynamic buffer in a re-circulating fashion to allow a user to control real time video viewing in a similar manner to a VCR. US 2003/0170003 is directed to a method for time shifting a video, which has a real time mode where real time video frames are delivered for display.

When surfing TV channels to find interesting content, often an interesting program or movie is found after the beginning portion. Unless the program or movie is rebroadcast the viewer does not have a convenient means for recording the beginning portion. A system is needed that allows personal video recording to capture the portion of the program that was missed because the viewer was late in accessing the particular TV program.

### SUMMARY OF THE INVENTION

It is an objective of the present invention to provide a system whereby an entire TV program from beginning to end can be recorded on a personal video recorder when the user was late in accessing the TV program.

It is also an objective of the present invention to request a beginning portion of a TV program from a server providing a TV program recording service of the TV program from the beginning of the TV program up to the point where viewing began.

It is further an objective of the present invention for the server to respond to the request for the beginning portion with an address and range that is used by the personal video recorder system to download the beginning portion.

It is still further an objective of the present invention to record in the personal video recorder both the TV program and the missed portion of the TV program while a user is watching the TV program.

In the present invention a personal video recorder is coupled to a server through a network. Through registration with the server, the personal video recorder is allowed to download from a storage system coupled to the server video content that was missed by the personal video recorder for which the user of the personal video recorder has a financial obligation for any missed downloaded portion. The missed video content can result from a user not scheduling the personal video recorder to start recording at the published start time of a TV program, or because the user while surfing TV broadcast came upon a TV program after the start of the program and decided to record the program including the beginning portion that was missed, or because the recording by the personal video recorder was interrupted by a perturbation from noise, dropped signal, momentary power outage and/or other reasons.

When the user (viewer) finds a TV program that has started and is liked, the user starts the personal video recorder to capture the remaining portion of a TV program. At the same time the user requests the personal video recorder to obtain the beginning portion of the TV program up to the point where recording was started. The personal video recorder signals a server, which provides a TV program recording service, and through a network provides the server with a TV program ID and the time at which recording on the personal video recorder commenced. The server responds with an address (such as a URL) and a range of data representing the missing portion of the TV program. The personal video recorder then requests the missing portion of the TV program using the address and the range of data previously provided by the server. A storage system associated with the server maintains a copy of the TV program for a period of time after the end of the broadcast of the program to allow users to download missing portions.

The present invention described herein can also be used to record on the personal video recorder a segment of a TV program that was interrupted by perturbations between the broadcaster and the user's TV set, i.e. noise, dropped signal and momentary power outage. In the case of recovering a perturbed segment, the user would have to provide to the server through the personal video recorder the program ID and the starting and ending time of the perturbed segment, or request either the first portion of the TV program to the point where the perturbation ends, or request the second portion of the TV program starting at the beginning of the perturbation and ending at the end of the TV program. As before, the server then responds with an address and a range of data that the personal video recorder uses to download through the network the desired portion of the TV program.

### BRIEF DESCRIPTION OF THE DRAWINGS

This invention will be described with reference to the accompanying drawings, wherein:

FIGS. 1A and 1B are block diagrams of the coupling between a personal video recorder, a server and a storage system of the present invention; and

FIG. 2 is a flow diagram of the method of the present invention to obtain a missing portion of a recorded TV program.

### DETAILED DESCRIPTION OF THE PREFERRED EMBODIMENT

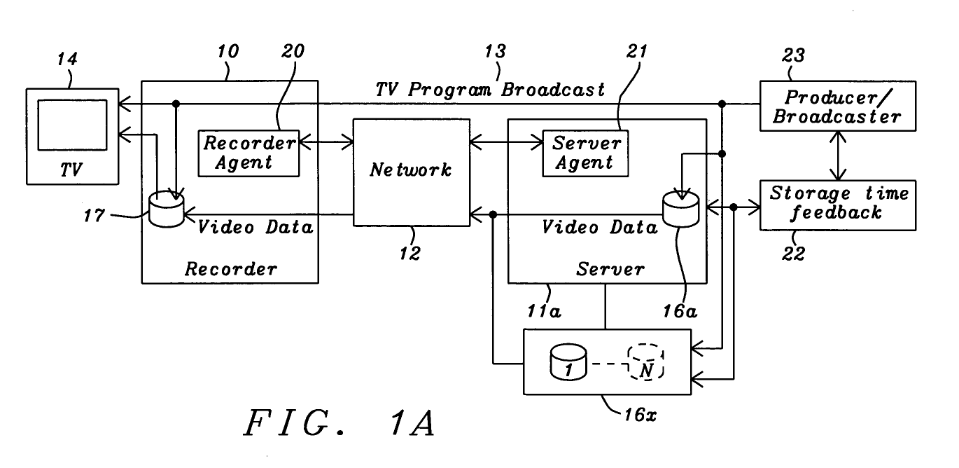

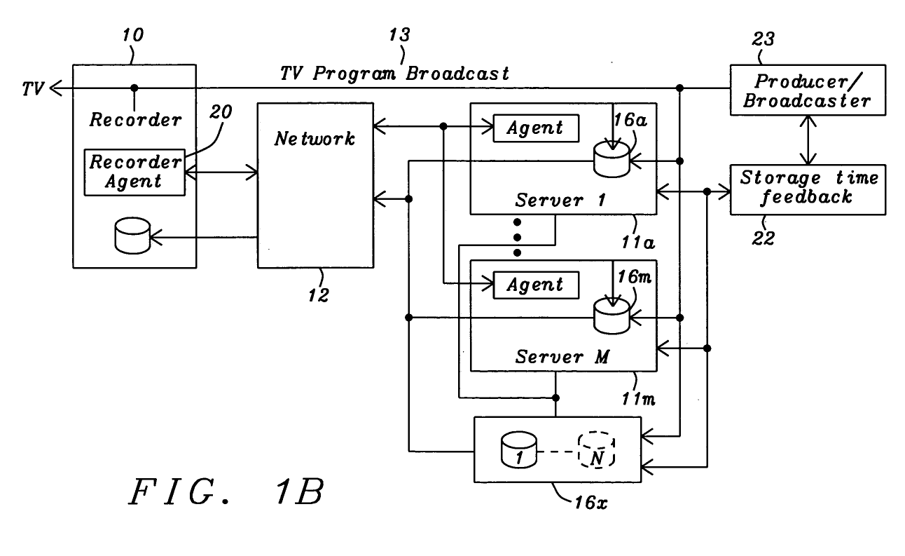

In FIG. 1A is shown a block diagram of the present invention where a personal video recorder 10 is coupled to a server 11a, which provides a video recording service, through a network 12, for example the Internet or equivalent communication networks. The network 12 communicates data to the server 11a and receives from the server 11a non-video data as well as video data, in which the video data is at least a portion of a TV program that is broadcast from a producer/broadcaster 23. A TV program broadcast 13, i.e. cable, satellite or other means, from a producer/broadcaster 23 is delivered to a TV 14 of a viewer (user) and is recorded on storage system 16a contained within the server 11a. A storage system 17 contained within the personal video recorder 10 also records the TV program broadcast 13 when the viewer activates the personal video recorder to capture the TV program broadcast. A storage system 16a within the server 11a provides a source of TV programs recorded prior to or during the TV program broadcast 13 from which the user of the recorder 10 can download portions of TV programs that have been missed or were corrupted. A storage system 16x comprising TV program files can be remote from the server 11a regardless of whether the server comprises a storage system 16a. The remote storage system 16x may comprise one to N storage units that are physically located together or physically distributed. A storage time feedback 22 provides feedback to the producer/broadcaster 23 the length of time that a TV program is maintained on a storage system 16a and 16x, and provides a mechanism by which the producer/broadcaster 23 can erase TV programs from storage when the TV program storage exceeds any predetermined agreement with respect to the storage of TV programs on the storage system 16a and 16x.

In FIG. 1B is shown a block diagram of the present invention where a personal video recorder 10 is coupled through a network 12 to a plurality or servers 11a to 11m, which provide video recording services. Similar to FIG. 1A, the plurality of servers 11a to 11m record a TV program broadcast 13 and maintains storage of the TV program in storage systems 16a to 16m. It should be noted that storage capacity requirement is flexible and not demanding and duplicate copies of a particular TV program is needed only under rare extenuating circumstances, which might be done where bandwidth, storage problems or other special considerations were deemed important. An external storage system 16x comprising storage units (1-N) can be used to store TV programs broadcast from the producer/broadcaster 23. The external storage system 16x is shared between the servers (server 1 to server M) and is physically located separate from the servers. The storage units (1-N) of the external storage system may be located together or distributed separately. The storage systems 16a to 16m within servers 11a to 11m may or may not exist concurrently with the external storage system 16x, and the producer/broadcaster 23 monitors the storage of TV programs through the storage time feedback 22 on all active storage systems 16a to 16m and 16x storage units one to N.

Referring again to FIG. 1A, the personal video recorder is registered with the server 11a, and informational communication is carried out between the recorder agent 20 within the personal video recorder 10 and the server agent 21 within the server 11a. The communications between the recorder agent 20 and the server agent 21 is conducted through a network, i.e. the internet, private cable or phone network, or any other existing network comprising cellular, wireless and radio network, coupling between the recorder agent and the server agent.

As is often the case, a viewer may not have set the personal video recorder 10 to record a particular TV program broadcast or may have not been aware that a particular TV program was of interest, thus missing an initial portion of the broadcast. The viewer may also have been surfing the available TV channels looking for content of interest. In any case, when a viewer finds a TV program broadcast that is interesting after the beginning portion of the broadcast, the present invention provides the method and apparatus to obtain the portion of a TV program broadcast that is not initially included in the recording in the personal video recorder 10, such as the beginning portion within the time frame of the broadcast. Also if there are segments of the broadcast that have been corrupted by noise or other impediments, i.e. interference or power failure, the method and apparatus of the present invention provides a recovery mechanism for the corrupted segments.

For example; a viewer starts surfing the available TV channels and finds subject material on a particular channel that is interesting after the start of the program. Upon realizing that the content of the broadcast material is of interest, the viewer starts recording the TV program and requests the personal video recorder 10 to obtain the beginning portion of the TV program that has been missed. The recorder agent 20 sends a message through the network 12 to the server agent 21 indicating the TV program identification and the time range of the beginning segment that has been missed. The server agent 21 responds to the recorder agent with an address (such as a URL) and the range of data that is to be downloaded. The recorder agent then requests the storage system 16a or 16x to provide the beginning or other portions of the TV program. The storage system 16a or 16x provides the video data that has been requested to the recorder storage system 17. The obtaining of the video data of the missing portion of the TV program as well as the recording of the current portion of the TV program can be accomplished simultaneous or after the viewer watching the TV broadcast 13 on the TV set 14. The missed portion of the TV program is inserted or concatenated in a fashion that any replay of the TV program will appear as originally broadcast

If there is a corrupted and/or missing segment, the viewer (user) requests the personal video recorder to obtain a replacement for the corrupted segment. If there are multiple corrupted and/or missing segments, the personal video recorder, after receiving the recording request from the viewer (user), obtains a replacement for each of the corrupted and/or missing segment.

It should be noted, it is within the scope of this invention that the personal video recorder can be a handheld device or an integrated portion of the handheld device, and the TV can be a display on the handheld device or a display coupled to the hand held device

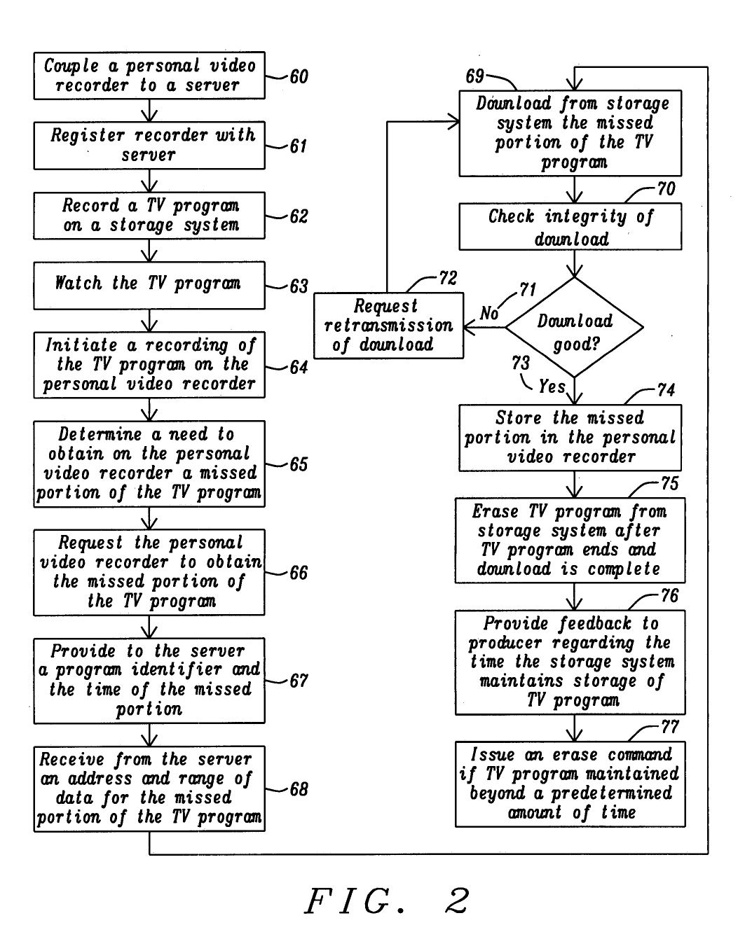

In FIG. 2 is shown a flow diagram for the method of the present invention to recover missed segments of broadcast TV programs. A personal video recorder is coupled to a server 60 through a network, i.e. the internet, private cable or phone network, or similar messaging networks. The personal video recorder is registered with the server 61 to insure identity of the user of the services and that proper payments are made for the services. A TV program as it is broadcast, which comprises advertisement and program content, is recorded on a storage system 62. The storage system is either integrated into the server or external to the server. The user (or viewer) while watching the TV program broadcast on a TV set 63, initiates the recording of the broadcast TV program on the personal video recorder 64. Either because the start of the recording of the TV program was initiated after the start of the broadcast, or because of perturbations in the broadcast, i.e. power failure of interference, there is a missed segment in the broadcasted TV program in the personal video recorder. The user decides there is a need to obtain the missed segment, or portion, of the broadcasted TV program 65, and the user requests the personal video recorder obtain the missed segment or portion of the broadcasted TV program 66. The recorder agent in the personal video recorder provides to the server agent, located in the server, the identifier of the TV program and the time of the missed segment, or portion, of the broadcasted TV program 67. The server agent responds to the recorder agent with an address (such as a URL) and range of the missed TV program data 68 that can be downloaded through the network, where the network comprises the internet, private cable or phone network, or any other existing network, comprising cellular, wireless and radio network. The personal video recorder requests the missing segment of the broadcast TV program from the storage system 69 using the address and the range of the missed TV program data that was sent by the server agent. Upon receipt of the data of the missing segment or portion of the broadcast TV program, the data is checked for integrity 70. If the data is found to be corrupted 71, the personal video recorder requests a retransmission of the download 72, and the storage system downloads the missing segment 69. If the download is found to be good 73, the missed portion of the broadcasted TV program is stored into the storage system of the personal video recorder 74. The TV program is erased from the storage system after a predetermined period of time from the completion of the broadcast of the TV program 75. During the time that the TV program is active on the storage system, the user of the personal video recorder may request a download of the TV program including the entire program, which allows a user who determines a need to have a copy at the very end of the TV program to obtain a copy. Storage time feedback is provided from the storage system to the producer/broadcaster to allow the producer/broadcaster to monitor the amount of time the TV program is maintained on the storage system 76. If the TV program is maintained on the storage system beyond the predetermined period of time, the producer/broadcaster issues a command through the storage time feedback to erase the TV program from the storage system 77.

Referring back to FIGS. 1A and 1B, it should be noted that it is within the scope of the present invention that the network 12 is an integral part of the TV program broadcast system 13 whereby a missed portion of a TV program broadcast is requested by the recorder 10 and downloaded to the recorder either simultaneous to the TV program broadcast or after the TV program broadcast is completed. For example, cable can provide the TV program broadcast as well as the two way communications necessary to request a missed portion of a TV program and to communicate the missed portion to the recorder, thus negating the need to have a separate network 12. In the case of a TV program broadcast 13, which is transmitted over a medium that does not provide two way communications, satellite for example, a separate communication medium, the Internet for example, can be used as the network 12 to request and receive a missed portion of a TV program. It is also within the scope of the present invention that a communication medium, such as satellite or cable, could provide the missed portion of the TV program while the internet or equivalent communication media is used to request the missed portion of the TV program.

While the invention has been particularly shown and described with reference to preferred embodiments thereof, it will be understood by those skilled in the art that various changes in form and details may be made without departing from the spirit and scope of the invention.

What is claimed is:

1. A personal video recording system, comprising:
a) a storage system for recording a broadcast TV program from beginning to end;
b) a personal video recorder coupled by a network to a server;
c) said personal video recorder records said TV program starting at a point where viewing of the TV program commences;
d) a viewer of the TV program requests the personal video recorder to obtain a missed portion of the TV program;
e) the personal video recorder communicates with the server through said network to request the missed portion; and
f) the server responds to the personal video recorder with an address and range of data by which the personal video recorder uses to download through the network the missed portion of the TV program from the storage system, and stores the missed portion in the personal video recorder.

2. The system of claim 1, wherein said network forms a part of a TV broadcasting system, whereby the personal video recorder requests from said TV broadcasting system the missed portion and receives from said TV broadcasting system the missed portion of the TV program.

3. The system of claim 1, wherein said network is independent of a TV broadcasting system, which couples said TV program to the personal video recorder, whereby said network requests and couples the missed portion of the TV program to the video recorder.

4. The system of claim 1, wherein said network requests the missed portion wherein the network is independent of a broadcasting system coupling said TV program to the personal video recorder and said broadcasting system couples the missed portion to the personal video recorder.

5. The system of claim 1, wherein said network requests and downloads the missed portion through said network comprising cellular, wireless or radio networks.

6. The system of claim 1, wherein said storage system is contained within said server.

7. The system of claim 1, wherein said storage system is external to said server.

8. The system of claim 7, wherein said storage system external to said server comprises at least one storage unit.

9. The system of claim 7, wherein said storage system external to said server is shared with a least one additional server.

10. The system of claim 1, wherein said missed portion of the TV program is a beginning portion of the TV program up to where recording of the TV program by the personal video recorder commences and other portions after recording of the TV program by the personal video recorder commences.

11. The system of claim 1, wherein said missed portion of the TV program is a segment of the TV program after recording of the TV program by the personal video recorder commences.

12. The system of claim 11, wherein said segment has been corrupted by perturbations in the normal transmission of the broadcast of the TV program.

13. The system of claim 1, wherein said personal video recorder is registered with the server.

14. The system of claim 1, wherein said TV program includes all broadcast data comprising advertisements and TV program contents.

15. The system of claim 1, wherein said address and range of data of the missed portion of the TV program allows said personal video recorder to access said missed portion through said network coupling the personal video recorder to the server.

16. The system of claim 1, wherein said server maintains said TV program in a storage system for a period of time after a scheduled end of a broadcast of the TV program to permit completion of a downloading of any said missed portion of the TV program.

17. The system of claim 1, wherein said personal video recorder records said TV program and any requested missed portion simultaneous to said viewer watching said TV program.

18. A method of recording a complete TV program commencing after a beginning of the TV program, comprising:
a) coupling a personal video recorder through a network to a server;
b) registering the personal video recorder with the server;
b) recording a TV program on a storage system associated with the server;
c) watching said TV program by a viewer;
d) initiating a recording the TV program on the personal video recorder;
e) determining a need to record a missed portion of the TV program;
f) requesting the personal video recorder to obtain said missed portion;
g) providing to the server through said network a program identifier and a time of the missed portion;
f) receiving from said server an address and range of requested video data representing the missed portion;
g) downloading from said storage system the missed portion of the TV program;
h) checking integrity of the missed portion downloaded from the storage system;
i) requesting a retransmission of the missed portion if the integrity check fails and returning to step g);
j) storing said missed portion of the TV program in the personal video recorder if the integrity check is good; and
k) erasing the TV program from the storage system after a predetermined amount of time beyond completion of TV program broadcast;

19. The method of claim 18, further comprising an issuing of an erase command by a producer/broadcaster of the TV program if the TV program is maintained on the storage system beyond the predetermined amount of time beyond completion of TV program broadcast.

20. The method of claim 18, wherein said network forms a part of a TV broadcasting system, whereby the personal video recorder requests from said TV broadcasting system the missed portion and receives from said TV broadcasting system the missed portion of the TV program.

21. The method of claim 18, wherein said network is independent of a TV broadcasting system, which couples said TV program to the personal video recorder, whereby said network requests and couples the missed portion of the TV program to the personal video recorder.

22. The method of claim 18, wherein said network requests the missed portion wherein the network is independent of a broadcasting system coupling said TV program to the personal video recorder and said broadcasting system couples the missed portion to the personal video recorder.

23. The method of claim 18, wherein requesting and downloading the missed portion is through networks comprising cellular, wireless or radio networks.

24. The method of claim 18, wherein said storage system is integrated into said server.

25. The method of claim 18, wherein said storage system is located external to the server.

26. The method of claim 25, wherein said storage system located external to the server is shared by at least two servers.

27. The method of claim 18, wherein said missed portion of the TV program is a beginning portion of the TV program up to where recording of the TV program by the personal video recorder commences and other portions after recording of the TV program by the personal video recorder commences.

28. The method of claim 18, wherein said missed portion of the TV program is a segment of the TV program after recording of the TV program by the personal video recorder commences.

29. The method of claim 28, wherein said segment has been corrupted by perturbations in the normal transmission of the broadcast of the TV program.

30. The method of claim 18, wherein said personal video recorder is registered with said server.

31. The method of claim 18, wherein said TV program includes all broadcast data comprising advertisements and TV program content.

32. The method of claim 18, wherein said address and range of the requested data allows the personal video recorder to access the missed portion of the TV program through the network coupling the personal video recorder and the storage system.

33. The method of claim 18, wherein said storage system maintains the TV program in the storage system of the server for a period of time after a scheduled end of a broadcast of the TV program to permit completion of the downloading of the missed portion.

34. The method of claim 18, wherein said personal video recorder records the TV program and any requested missed portion simultaneous to the viewer watching the TV program.

35. A TV program recording system, comprising:
a) a means to record a TV program at a storage system associated with a server;
b) a means to record the TV program in a personal video recorder;
c) a means to request from said storage system a portion of the TV program missed by said personal video recorder; and
d) a means to download through a network said portion of the TV program missed by the personal video recorder.

36. The system of claim 35, wherein said means to request the portion of the TV program missed by the personal video recorder comprises sending to the server through the network a program identifier and a time range of the TV program that was missed.

37. The system of claim 35, wherein said means to download the portion of the TV program missed, further comprises:
a) a means for requesting a missed portion of the TV program from the server by the personal video recorder;
b) a means for receiving an address and a data range from said server through a network connecting the personal video recorder and the server; and
c) a means for downloading the missed portion of the TV program from a storage system through the network simultaneous to a user viewing the TV program.

38. The system of claim 37, wherein said network forms a part of a TV broadcasting system, whereby the personal video recorder requests from said TV broadcasting system the missed portion and receives from said TV broadcasting system the missed portion of the TV program.

39. The system of claim 37, wherein said network is independent of a TV broadcasting system, which couples said TV program to the personal video recorder, whereby said network requests and couples the missed portion of the TV program to the personal video recorder.

40. The system of claim 37, wherein said network requests the missed portion wherein the network is independent of a broadcasting system coupling said TV program to the personal video recorder and said broadcasting system couples the missed portion to the personal video recorder.

41. The system of claim 37, wherein said network requests and downloads the missed portion through said network comprising cellular, wireless or radio networks.

42. The system of claim 37, wherein said storage system is an integral part of said server.

43. The system of claim 37, wherein said storage system is physically separate from the server.

44. The system of claim 43, wherein said storage system is shared between at least two servers.

45. The system of claim 35, wherein the means to record a TV program in a personal video recorder comprises recording both the TV program and the missed portion of the TV program while a user is viewing the TV program.

46. The system of claim 45, wherein recording both the TV program and the misses portion of the TV program includes all broadcast data comprising advertisements and contents of the TV program.
